(19) United States
(12) Patent Application Publication
(10) Pub. No.: US 2025/0220373 A1
(43) Pub. Date: Jul. 3, 2025

(54) WIRELESS MULTI-CHANNEL AUDIO SYSTEM

(71) Applicant: Sennheiser electronic SE & Co. KG, Wedemark (DE)

(72) Inventors: Jan Watermann, Hannover (DE); Sebastian Georgi, Langenhagen (DE); Steffen Matthias, Hannover (DE)

(73) Assignee: Sennheiser electronic SE Co. KG, Wedemark (DE)

(21) Appl. No.: 18/978,103

(22) Filed: Dec. 12, 2024

(30) Foreign Application Priority Data
Dec. 27, 2023 (DE) 102023136694.7

(51) Int. Cl. H04S 3/00; H04R 5/02; H04R 5/027; H04R 5/033

(52) U.S. Cl. CPC H04S 3/006; H04R 5/02; H04R 5/027; H04R 5/033; H04R 2420/07; H04S 2400/01

(57) ABSTRACT

A wireless multi-channel audio system according to ETSI EN300422 is provided, which has at least one mobile audio data transmitter (30, 40), at least one mobile audio data receiver (50, 60) and a wireless base station (10) which is configured to receive audio data from the at least one audio data transmitter (30, 40) and to transmit audio data to the at least one mobile audio data receiver (50, 60) in a time division multiplex access (TDMA) method. The audio data comprise m audio channels, wherein n audio samples can be transmitted per slot and wherein audio samples from at least two of the m audio channels are transmitted per slot. The following applies: m≥2.

The present invention relates to a wireless multi-channel audio system and a method for controlling a wireless multi-channel audio system.

Wireless multi-channel audio systems are known from ETSI EN 300422, for example as a Wireless Multichannel Audio System WMAS. Such an audio system is a wireless audio system in which several channels are used for audio transmission. Thus, for example, several microphones or several in-ear monitoring units can be used simultaneously with one base station.

If several audio transmitters (for example a handheld microphone or other microphones) simultaneously transmit audio signals to a base station and the base station transmits a second audio signal composed of these audio signals to an in-ear monitoring unit or a bodypack or a beltpack, then the microphones do not transmit simultaneously, but the subscriber access is accomplished by a Time Division Multiple Access TDMA system.

The TDMA method ensures multiple access to a wireless audio transmission through a temporal sequence of several subscribers. For transmission with low latency, for example, a deterministic and equidistant raster of time slots per audio channel can be used. The minimum latency is determined by the largest distance between two consecutive time slots.

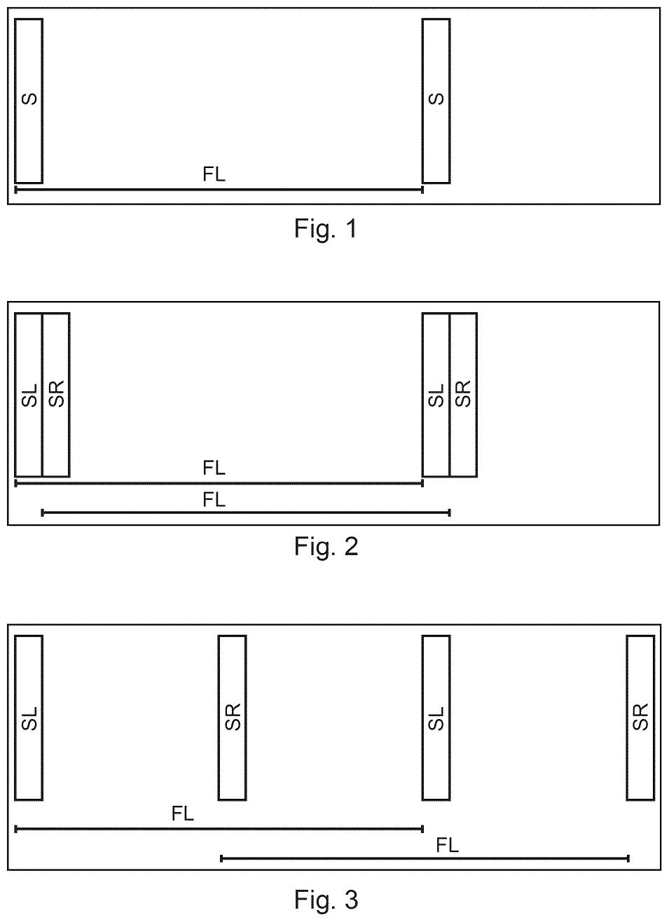

FIGS. 1 to 3 show various possibilities for audio transmission in a wireless multi-channel system according to the prior art. For example, 48 audio samples S can be transmitted in one burst. The frame latency FL can be 1 ms, i.e. the interval between two consecutive bursts with audio samples is, for example, a few ms. The sampling frequency here is 48 KHz. 48 audio samples can be transmitted in one time slot. FIG. 2 shows how the audio samples are divided into samples of a left channel SL and a right channel SR. Here, the samples of the right channel are also transmitted directly after the transmission of the left channel. FIG. 3 shows a situation where there is a time interval between the transmission of the left channel SL and the right channel SR.

In the three transmission options shown above, a transmission of a sample for the left channel and a sample for the right channel will inevitably increase the latency. For example, if the wireless multi-channel audio system is used to transmit audio signals from a left and a right channel (stereo) in a concert or the like, then too high a latency of the audio signal is unacceptable.

In the priority application of this application, the German Patent and Trademark Office has searched the following documents: DE 10 2021 116 893 A1 and DE 10 2009 031 995 A1.

It is therefore an object of the present invention to provide a wireless multi-channel audio system having reduced latency.

This object is achieved by a wireless multi-channel audio system according to claim 1 and by a method for controlling a wireless multi-channel audio system according to claim 7.

A wireless multi-channel audio system is provided, in particular in accordance with ETSI EN300422, which has at least one mobile audio data transmitter, at least one mobile audio data receiver, and a wireless base station which is configured to receive audio data from the at least one audio data transmitter and to transmit audio data to the at least one mobile audio data receiver in a Time Division Multiple Access (TDMA) method. The transmission takes place in frames, wherein each frame comprises a number of time slots. The audio data has m audio channels, wherein n audio samples can be transmitted per slot and wherein in each slot audio samples are transmitted from at least two of the m audio channels. It holds that m≥2. This means that the frame latency for transmission of a stereo signal, for example, can be significantly reduced.

According to one aspect, audio samples of a first audio channel are transmitted first in one slot and then audio samples of a second audio channel are transmitted, or the audio samples of the first and second audio channels are transmitted alternately.

According to one aspect, frame latency is reduced depending on the number of audio channels.

According to one aspect, for each audio channel, n/m samples are transmitted per slot.

According to one aspect, the wireless transmission of the audio data takes place in a frequency range of 470-698 MHZ (UHF) or 1350-1525 MHZ (1G4).

The transmission of an audio channel can take place in the form of a transmission of an audio stream.

Further embodiments of the invention are the subject of the dependent claims.

Advantages and exemplary embodiments of the invention are explained in more detail hereinafter with reference to the drawing.

FIGS. 1 to 3 each show a schematic representation of a transmission of samples in a wireless multi-channel audio system according to the prior art,

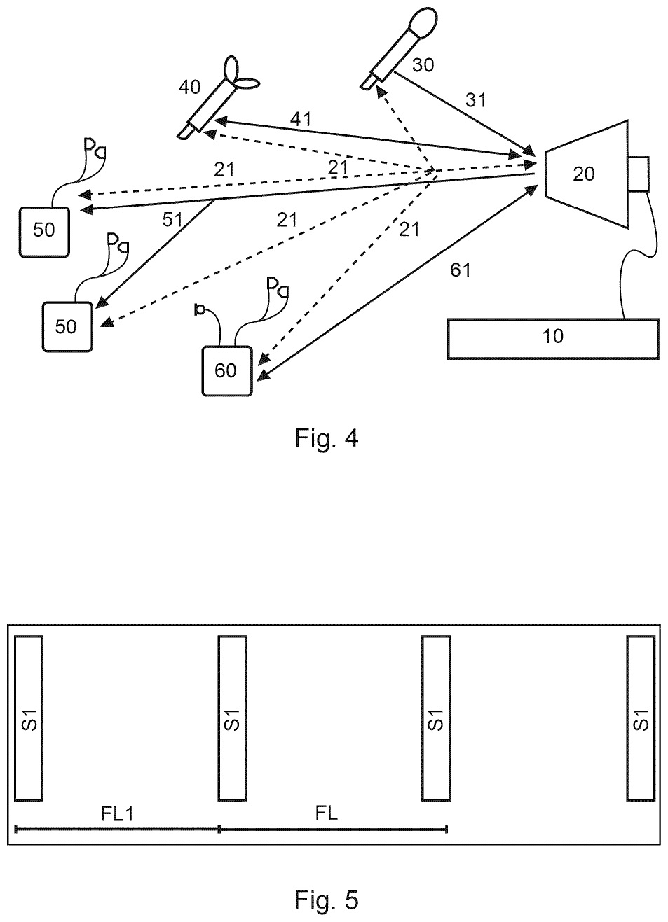

FIG. 4 shows a schematic representation of a wireless multi-channel audio system according to a first embodiment, and

FIG. 5 shows a schematic representation of a sample transmission in a wireless multi-channel audio system of FIG. 4.

FIG. 4 shows a schematic representation of a wireless multi-channel audio system according to a first exemplary embodiment. The wireless multi-channel audio system WMAS 1 is based on ETSI EN 300422, e.g. as Wireless Multichannel Audio System WMAS, and has a base station 10, at least one antenna 20 and mobile devices, e.g. at least one handheld microphone (mobile transmitter) 30, optionally at least one multi-channel microphone (mobile transmitter) 40, optionally a first bodypack or beltpack (mobile receiver) 50 with an output for in-ear monitoring, optionally a combined second bodypack or beltpack (mobile receiver) 60 with an input for microphone signals and an output for in-ear monitoring. Thus, the number of mobile transmitters 30, 40 or mobile receivers 50, 60 in the wireless multi-channel audio system 1 can vary.

The microphone 30 transmits audio data 31 to the base station 20. The bodypack or beltpack (mobile transmitter) 60 transmits audio signals 61 to the base station 10 (via the antenna 20).

The base unit 10 can transmit control data 21 to the respective mobile devices, e.g. transmitter/receiver 30, 40, 50, 60, via the antenna 20. The communication from the base station 10 to the mobile devices 50, 60 can take place in a multicast or in a broadcast and the communication from the mobile devices 30, 40 to the base station 10 can take place in a unicast.

The handheld microphone 30 transmits audio data as first audio data 31 wirelessly as a unidirectional radio transmission 31. This transmission 31 can take place in a unicast. The audio transmission can take place in the form of mono-microphone data. The microphone 40 transmits second audio signals 41 in the form of a unidirectional radio transmission. Here stereo or multi-channel microphone data can be transmitted in a unicast. The first and second bodypack or beltpack 50, 60 (mobile receiving units) receive a unidirectional radio transmission (audio data 51, 61) from the base station 10. This radio transmission can, for example, comprise in-ear monitoring data. The audio data 51, 61 can be composed of the first and second audio data 31, 41 and optionally further audio data. This data can be transmitted as a unicast or multicast. The second bodypack or beltpack 60 (receiving unit) communicates with the base unit 10 in the form of a bidirectional radio transmission. The microphone data that the bodypack or beltpack has received via the microphone input is transmitted to the base station as a unicast, for example. In-ear monitoring data is transmitted from the base station as a unicast or multicast.

FIG. 5 shows a schematic representation of an audio transmission in a wireless multichannel audio system from FIG. 4. Whereas in FIGS. 1 to 3 each slot only comprises audio samples from one channel (or one audio stream), the audio transmission according to the invention is configured in such a manner that the audio samples in one slot S1 come from at least two audio channels (audio stream of the left channel and audio stream of the right channel). This means that in one slot only half of the transmittable samples are transmitted per channel, but the procedure according to the invention is advantageous because a latency between the audio signals, e.g., of the left and right channels can thus be reduced. The frame latency for transmission of a stereo signal can thus be significantly reduced.

This is achieved by transmitting audio samples of the audio channels to be transmitted in a mixed or distributed manner per slot. For example, if two audio channels (left channel, right channel) are present, then half of the possible samples from the left channel and half of the possible samples from the right channel can be transmitted in one slot.

If a multi-channel audio system is to be provided, where more than two audio channels are to be transmitted from the base station to the mobile receivers, then the transmittable audio samples in one slot must be divided between the available audio channels. If three audio channels are to be transmitted, for example, then the possible number of transmittable samples in one slot can be divided between the three audio channels, i.e., audio samples of the available audio channels (or audio streams) are transmitted in each slot.

Thus, each of the audio channels only contributes a portion of the audio samples in one slot. The transmission of audio samples per channel per slot is thus reduced, but this is compensated by the reduced frame latency between successively transmitted frames.

According to one aspect of the present invention, the data rate per channel per slot_is initially reduced. However, this reduction is compensated by reducing the latency of the successive frames.

Audio signals from two or more audio channels can be transmitted in one slot. During a transmission of a stereo signal (2 channels, left channel and right channel) half as many sampled values of the left channel and half as many sampled values of the right channel can be provided in one slot. In order to achieve the same data rate, the slots must be repeated more frequently. In one frame the slots S1 are therefore transmitted twice. For example, the first half of the two audio channels can be transmitted in the first slot and the second half in the second slot. The data rate remains the same but the latency is reduced.

The frame latency FL for an audio channel can be reduced because the audio samples of the audio channel are transmitted at shorter intervals. This is achieved whereby slots not only have audio samples of one audio channel but audio samples of at least two audio channels. The slots are therefore divided over several channels.

The wireless multi-channel audio system WMAS is an audio system in accordance with EN300422. In this system, the channel bandwidth can be 6 MHZ, 8 MHz or 10 MHz. The audio data (as audio streams) can be transmitted in a frequency range of 470-698 MHZ (UHF) or 1350-1525 MHZ (1G4). For example, the following frequency bands can be used as frequency bands for the transmission: TV-UHF (470-608 MHZ); TV-UHF China (470-510 MHz and 610-698 MHZ); L-Band CEPT (1350-400 MHZ); L-Band USA (1435-1525 MHz).

Subscribers access the transmission channels using Time Division Multiple Access (TDMA). Optionally, the number of subscribers can be up to 128 independent audio channels per broadband channel. The modulation method can be Orthogonal Frequency Division Multiplexing (OFDM) in combination with various subcarrier modulation or coding methods. Audio coding can be accomplished using different methods and sampling rates, as well as in mixed mode. For example, sampling rates can be 48 KHz or 96 KHz. Audio coding can be accomplished using the OPUS method, the ADPCM method, the PCM method, or another suitable method. Synchronization of the TDMA raster and the carrier offset estimate (CFO estimation) can be ensured using synchronization patterns. A basic TDMA raster is ≤10 ms and can be divided into ½, ¼, ⅛, or 1/16 sub-rasters.

According to one aspect of the present invention, the audio transmission can be encrypted. The base station 10 can provide a synchronization signal, manage connected or paired devices and can allocate the corresponding communication resources. The base station 10 can generate a third and/or fourth audio signal from the received first and second audio signals, which can represent a mixture of the first and second audio signals. These third or fourth audio signals can then represent an in-ear monitoring audio signal. The base station receives the first and second audio signals, namely the microphone signals.

The mobile devices 30, 40, 50, 60 can register with the base station 10 to enable communication with the base station 10. The mobile devices 30, 40, 50, 60 can optionally initiate a transmission of audio data if they have previously detected a base station 10 with which they should communicate.

According to one aspect of the present invention, the base station can transmit the third and/or fourth audio signals, namely the in-ear monitoring signals, as a multicast, so that several mobile devices 50, 60 can capture the third and fourth signals (in-ear monitoring signals) and forward them to their respective audio outputs.

According to one aspect of the present invention, the mobile devices 30, 40, 50, 60 can also optionally communicate with each other and exchange data.

The audio transmission method according to the invention can be used for any TDMA audio transmission, as long as a transmission from a base station to a receiver has audio signals from at least two audio channels (or two audio streams). An example of such a wireless multi-channel audio system is in-ear monitoring systems, where the base station mixes an audio signal based on several audio channels and then transmits this signal wirelessly to in-ear monitoring units.

The base station must therefore have audio data that has multiple (at least two) audio channels. These audio channels can come from an external source or from wireless microphones in the multi-channel audio system.

According to one aspect of the present invention, the bodypacks or beltpacks may be capable of outputting a stereo signal at the audio output.

According to one aspect of the present invention, the frame latency can be reduced when more than two audio channels are to be transmitted. This can be accomplished, for example, when a multi-channel wireless microphone is used.

According to a further aspect of the present invention, each receiver of the audio samples must check whether the audio samples contained in the frame are intended for it or not. This can be particularly important in a multi-channel audio system, for example when more than two audio channels are transmitted.

According to one aspect, the hardware components described can be linked to form a system by “pairing” the mobile devices with the base station. Pairing takes place in several steps. Firstly, the operator decides at which frequency the base station will provide the RF channel. Optionally, the base station is set up to identify other transmitters in the permitted frequency band so that the operator can select the frequency for the RF channel so that, if possible, no interference from other transmitters occurs. The base station sends a control slot on the RF channel within a superframe. The control slot contains a unique ID of the base station. After the pairing process has been triggered on the mobile device, for example by pressing a button on the mobile devices, the mobile device searches for an RF signal, finds the RF channel of the base station and reads the control slot. In another control slot, the mobile device then sends its own unique ID to the base station and is displayed there as a device that is ready for pairing. The operator of the base station confirms that the mobile device has been found and saves the unique ID of the base station. The mobile device receives confirmation from the base station with the next control slot and for its part saves the unique ID of the base station. The mobile devices are only ready to send a signal after pairing. The mobile devices are typically paired with the base station by a sound engineer before a production so that unpaired devices cannot “listen in” at a later date. Furthermore, it is not possible for the base station to process signals from unpaired devices.

1. Wireless multi-channel audio system, in particular in accordance with ETSI EN300422, comprising
at least one mobile audio data transmitter (30, 40) for wirelessly transmitting audio data,
at least one mobile audio data receiver (50, 60), and
a wireless base station (10) which is configured to receive audio data from the at least one audio data transmitter (30, 40) and to transmit audio data to the at least one mobile audio data receiver (50, 60) in a Time Division Multiplex Access (TDMA) method,
wherein the audio data comprises m audio channels, wherein n audio samples can be transmitted per slot, wherein audio samples from at least two of the m audio channels can be transmitted in each slot,
where m≥2.

2. Wireless multi-channel audio system according to claim 1, wherein
firstly audio samples of a first audio channel and then audio samples of a second audio channel are transmitted in a slot or wherein audio samples of the first and second audio channels are transmitted alternately in the slot.

3. Wireless multi-channel audio system according to claim 1, wherein
a frame latency is reduced depending on the number of audio channels.

4. Wireless multi-channel audio system according to claim 1, wherein
for each audio channel n/m samples per slot are transmitted.

5. Wireless multi-channel audio system according to claim 1, wherein
the wireless transmission of audio data takes place in a frequency range of 470-698 MHz or 1350-1525 MHz.

6. Wireless multi-channel audio system according to claim 1, wherein
the frame latency for an audio transmission is <10 ms.

7. Method for controlling a wireless multi-channel audio system, in particular according to ETSI EN300422, which comprises at least one mobile audio data transmitter (30, 40), at least one mobile audio data receiver (50, 60) and a wireless base station (10), comprising the steps:
receiving audio data from the at least one audio data transmitter (30, 40) in a Time Division Multiplex Access (TDMA) method by a wireless base station (10), and
transmitting audio data to the at least one mobile audio data receiver (50, 60) by the wireless base station (10),
wherein the audio data comprises m audio channels, wherein n audio samples are transmittable per slot, wherein audio channels from at least two of the m audio channels are transmitted per slot,
where m≥2.
